(19) United States
(12) Patent Application Publication
(10) Pub. No.: US 2006/0277270 A1
(43) Pub. Date: Dec. 7, 2006

(54) Record and playback of server conversations from a device

(75) Inventors: Owen Winston Lloyd, Bothell, WA (US); Eian Dae Counts, Daechi-Dong (KR); Karthik Thirumalai, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/145,365

(22) Filed: Jun. 3, 2005

(51) Int. Cl. G06F 15/16

(52) U.S. Cl. 709/217

(57) ABSTRACT

The subject invention provides a system and/or a method that facilitates the recording of server/device communications on a device and playback of such recorded conversations from the device. Playback from the device can be implemented without a network connection and simulates a real server that has previously interacted with the device. The system provides for a device to communicate with at least one server, and a module integrated with device to playback at least one recorded server response to the device. Further, the system provides for a component integrated with the device to record server responses and device responses on the device and to store the recorded responses in a memory of the device. Upon staging the device to a state equal to when the conversation record log was created, the recorded server responses can be matched to corresponding device responses and played back to the device.

### BACKGROUND OF THE INVENTION

In order to track communications between a device and a server, conventional systems employ a “Man-in-the-Middle” technique (MITM). A middle server, between the device and server, acts as a recorder for the communication(s) that occurs between the device and the server. The device is configured to talk with the recorder and the recorder forwards all requests up to the server. Any information the server sends the recorder is then forwarded on to the device. Both the device and the server do not realize they are not directly communicating with each other. Thus, MITM is a technique that simultaneously fools two parties into thinking they are communicating with each other while, in fact, they are both talking to the “Man-in-the-Middle.”

The MITM approach is typically used to be able to read a public-key encrypted conversation. It relies on having complete access to all messages between the two parties wanting to communicate, e.g., parties A and B. All messages between A and B must pass between the “Man-in-the-Middle,” M. Upon the start of communication, the public keys must be exchanged between A and B. This is where M starts to interfere by creating its own key-pairs, for both A and B, that are distributed back to A and B in a way that M is able to decrypt, read, and encrypt as the messages pass by. A and B will think they are communicating though a secure channel, but only the channel between A and M, and M and B is actually secured and M can read and modify all of their messages. Since the parties do not detect the presence of an intermediary, such conventional systems present security concerns such as eavesdropping on the communications.

An eavesdropper is a network device, also known as a “sniffer,” that can implement MITM to intercept information being transmitted between parties. This sniffing takes place without the knowledge of either the client or server and is called passive monitoring. User data, including passwords, can be stolen this way if insecure protocols like telnet and FTP are employed. During such a MITM attack, if the first connection and host key exchange between a client and a particular host is compromised, the MITM attack fools both the client and server into thinking that they are communicating directly with one another when, in fact, an attacker is actually intercepting all traffic between the two parties. This technique usually requires very active involvement by the attacker. Often, it requires the constant involvement of the attacker from beginning to end of the communication in order to avoid detection. MITM is often attempted when the attacker desires communication with a system under the identity of a particular user. Often this user has some sort of secret information that the attacker cannot acquire.

Therefore, there is a need for systems that allow for the tracking of conversations between a device and server without relying on an intermediary party to record and forward the data exchanged.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention, in one aspect thereof, relates to a system and/or methodology that can record and playback server/device communications from a device. Such playback from the device can be implemented without a network connection and can simulate the actions of a real server that has previously interacted with the device. The system provides for a device to communicate with at least one server and a module integrated with the device to playback at least one recorded server response to the device. Such played back recorded server responses can be matched to device responses. Further, the system can provide for a component integrated with the device to record server responses and device responses on the device and to store the recorded responses in a memory of the device. The server/device communication responses can comprise of one or more layers implemented to effectuate data transmission, formatting, organization, and/or packing and unpacking. As an example, such layers can be Transmission Control Protocol/Intemet Protocol (TCP/IP) layers, Secure Sockets Layers (SSL), transport code layers, and the like.

A trigger file in the device can further provide by the system to be detected by an initial server response. Upon detection of the trigger file, an application program interface can be called to begin recording the server/device communications. The device can include a hook that facilitates the component to capture server response data of the at least one server response and/or device response data of the at least one device response, while recording the server/device communications. In one aspect, such captured data is located above the TCP/IP layer, above the SSL, but below the transport code layers. The hook can also facilitate the module to forward recorded server responses to the device during playback. In addition, the system can include a password handler component to facilitate the component in detecting password characters in order to substitute the password characters with random characters in device memory. During playback, the password handler component can also facilitate the module to playback a positive response to the device if the module detects password characters in a device response.

In another aspect, the subject invention relates to a server communication playback method. The method can include transmitting a conversation between a device and at least one server, recording the conversation on the device, storing a record of the conversation in device memory as a plaintext file, and executing the record back from the device without a network connection and at a device state equal to when the plaintext file was created.

In order to return the device to the desired state, the device can be staged. To facilitate staging of the device with an activated Send/Receive button of the device, the invention can create the same values the device had when the plaintext log file was created. Thus, the invention can set incoming/outgoing server names, usemames, passwords, day filters, etc. Folders or messages that were sunk down to the device via previous server sessions can be re-created. Outgoing mails and/or draft mails can be recreated within respective device folders. Device registries can be set to appropriate values, paths, names, headers, and/or filenames, etc.

Upon staging the device to an identical state from a point when the plaintext log file was created, the communications played back from the device can match up within the plaintext file. Playback can match up all outgoing device communications with the corresponding response from the server and ‘play’ that response back to the device. In other words, the invention can allow the device to ‘think’ it is receiving ‘played’ response from the server and act accordingly. Such identical playback can allow for reproduction of responses from a server that developers can employ in order to identify bugs, for example. Upon a developer implementing a fix for the problem, a tester can take that same log file and play it back to confirm the device now correctly handles what was once a failing case. At a later point in time, the tester can replay that same log to confirm the fixed functionality had not regressed from the fixed state.

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a high-level block diagram of a system in accordance with at least one aspect of the subject invention.

FIG. 2 illustrates a block diagram of a recording system in accordance with at least one aspect of the subject invention.

FIG. 3 illustrates a low level block diagram of a recording system in accordance with at least one aspect of the subject invention.

FIG. 4 illustrates a testing matrix utilizing artificial intelligence and one or more aspects of the subject invention.

FIG. 5 illustrates a flow diagram of a method of recording in accordance with at least one aspect of the subject invention.

FIG. 6 illustrates a flow diagram of a method of staging in accordance with at least one aspect of the subject invention.

FIG. 7A illustrates a flow diagram of a server response record method in accordance with at least one aspect of the subject invention.

FIG. 7B illustrates a flow diagram of a device response record method in accordance with at least one aspect of the subject invention.

FIG. 8 illustrates a flow diagram of a playback method in accordance with at least one aspect of the subject invention.

FIG. 9 illustrates an exemplary networking environment, wherein the novel aspects of the subject invention can be employed.

FIG. 10 illustrates an exemplary operating environment that can be employed in accordance with the subject invention.

### DESCRIPTION OF THE INVENTION

As utilized in this application, terms “component,” “system,” “interface,” “module,” “layer,” “message,” “device” and the like are intended to refer to a computer-related entity, either hardware, software (e.g., in execution), and/or firmware. For example, a module can be a process running on a device, a processor, an object, an executable, a program, and/or a computer. By way of illustration, both an application running on a server and the server can be a component, and a conversation can be exchange of information between and/or among a device and one or more servers. One or more components can reside within a process and a component can be localized on one computer and/or distributed between two or more computers. Furthermore, one or more modules can reside and/or be integrated with a device and/or other modules. As utilized in this application, terms such as “conversation,” “communication,” “layer,” and “session,” and the like are intended to refer to the exchange of data between and/or among a device and one or more servers. In addition, terms such as “response,” “message,” and “data” can further relate to information exchange between a server and a device and can be used interchangeably.

In addition, as utilized in this application, the following discussion relates to, but does not limit, services and communications between a device and server in accordance with one or more aspects of the subject invention. Accordingly, Post Office Protocol 3 (POP3) is a standard mail server commonly used on the Internet. It can provide a message store that holds incoming e-mail until users log on and download it. POP3 is a simple system with little selectivity. All pending messages and attachments are downloaded at the same time. POP3 uses the SMTP, infra, messaging protocol. Further, Internet Messaging Access Protocol (IMAP) is a standard mail server that can be widely used on the Internet. It provides a message store that holds incoming e-mail until users log on and download it. IMAP4 is the latest version.

IMAP is more sophisticated than the Post Office Protocol (POP3) mail server. IMAP messages can be archived in folders, mailboxes can be shared, and a user can access multiple mail servers. There can also better integration with Multipurpose Internet Mail Extensions (MIME), which is used to attach files. For example, users can read only the headers in the message without having to automatically accept and wait for attached files to download that they do not want. Both IMAP and POP accept SMTP-formatted messages that have been routed across the Internet.

Simple Mail Transfer Protocol (SMTP) is often considered the standard e-mail protocol on the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as POP3 or IMAP4, which provides a message store for incoming mail.

A Secure Sockets Layer (SSL) can be employed to provide privacy and reliability between two communicating entities. The protocol can be composed of two layers. At the lowest level, layered on top of a common transport protocol (e.g. TCP), is an SSL Record Protocol. The SSL Record Protocol is employed for encapsulation of various higher-level protocols. One such encapsulated protocol, an SSL Handshake Protocol, can enable the first and second party to authenticate each other and to negotiate an encryption algorithm and cryptographic keys before an application protocol transmits or receives its first byte of data. An advantage of SSL is that it is application protocol independent.

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

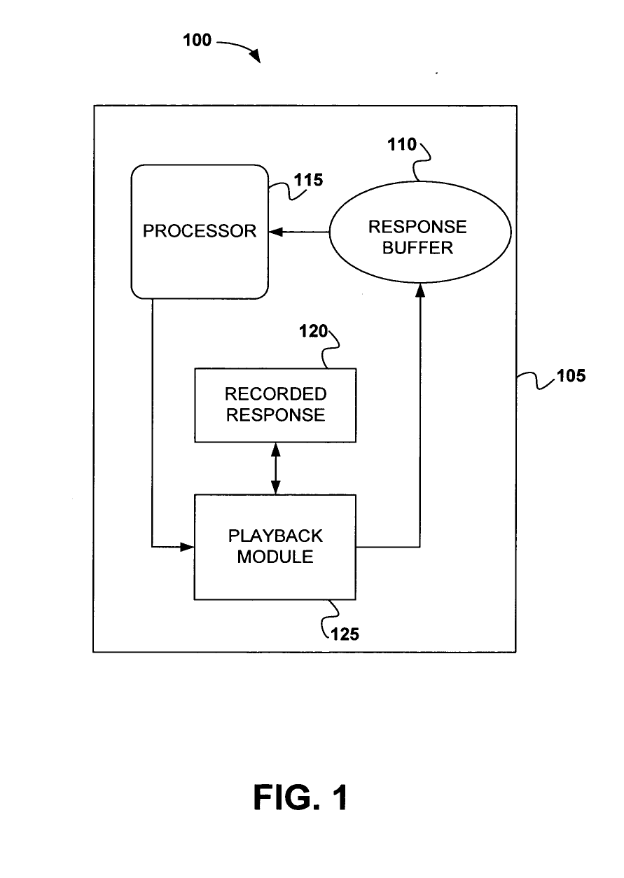

FIG. 1 illustrates a high-level block diagram of a system 100 in accordance with at least one aspect of the subject invention. The system 100 includes a device 105, a response buffer 110, a processor 115, a recorded response 120, and a playback module 125.

The recorded response 120 can be, for example, a recorded server response from a previous server session. When the device 105 is set to a state when the recorded response 120 was logged, the playback module 125 can play the recorded response 120 back to the device 105 in order to simulate the server while not requiring the device 105 to maintain a network connection. Thus, after the device 105 detects that it is at a device state equal to when the recorded response 120 was logged in device memory, the playback module 125 can access the recorded response 120 and play it back by sending it to the response buffer 110. The response buffer 110 can intake not only recorded responses 120 but also actual responses sent during actual sessions with one or more servers.

The playback module 125 plays back the recorded response 120 to the device 105 via the response buffer 110. The device processor 115 can process the data of recorded response 120 and produces a corresponding device response. The playback module 125 can match up the corresponding device response with another recorded response and ‘play’ that response back to the response buffer 110 without a network connection. Thus, the device 105 behaves as though it is actually communicating with a server, without a network connection. It is to be appreciated that the recorded response 120 can be a data, a data packet, a signal, and/or message sent between the device 105 and a server. In addition, the device 105 is not limited to storing only one recorded response 120 and can record and store plurality of responses.

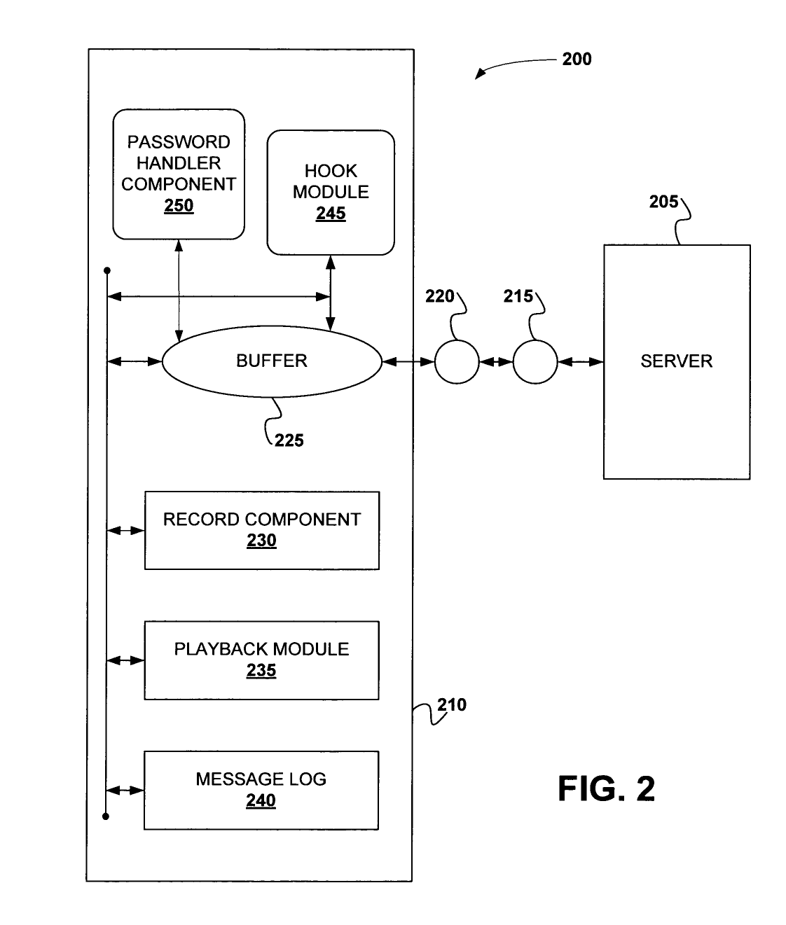

FIG. 2 illustrates a block diagram of a recording system 200 in accordance with at least one aspect of the subject invention. The recording system 200 includes a server 205, a device 210, a plurality of messages 215, 220, a buffer 225, a record component 230, a playback module 235, a message log 240, a hook module 245, and a password handler component 250. It is to be understood that although FIG. 2 depicts two messages 215, 220, the subject invention is not limited to the exchange of only two such messages. Further, each message 215, 220 can be either a device message or a server message depending upon origin.

In operation, the server 205 can send an initial server message 215 to the device 210. Upon the initial server message detecting a trigger file maintained by the device 210, the device 210 can call an application program interface to trigger a recording of the conversation between the server 205 and the device 210. Such a conversation can entail an exchange of a plurality of messages 215, 220. When one or more server messages reach the device 210, each message can placed in the buffer 225 for processing. The hook module 245 can coordinate with the record component 230 to filter and capture data from the server messages 215, 220 in the buffer 225. In addition, the password handler component 250 coordinates with the record component 230 to replace any password information in the captured data with garbage data in order to provide security during playback. The record component can place the captured data in the message log 240. The message log 240 can be, for example, a plaintext file as a recording of each server message and device message (e.g., 215, 220) exchanged by the device 210 and server 205 during a conversation. The message log 240 can include the captured data of each server and/or device message (e.g., 215, 220). As well, the message log 240 can include the message data filtered by the hook module 245. The device 210 is not limited to storing one message log 240, nor is the device 210 limited to interacting with one server 205. In addition, it is understood that the device 210 can engage in a plurality of conversations with a plurality of servers, and can concurrently record such conversations to be stored in the message log 240 for future playback.

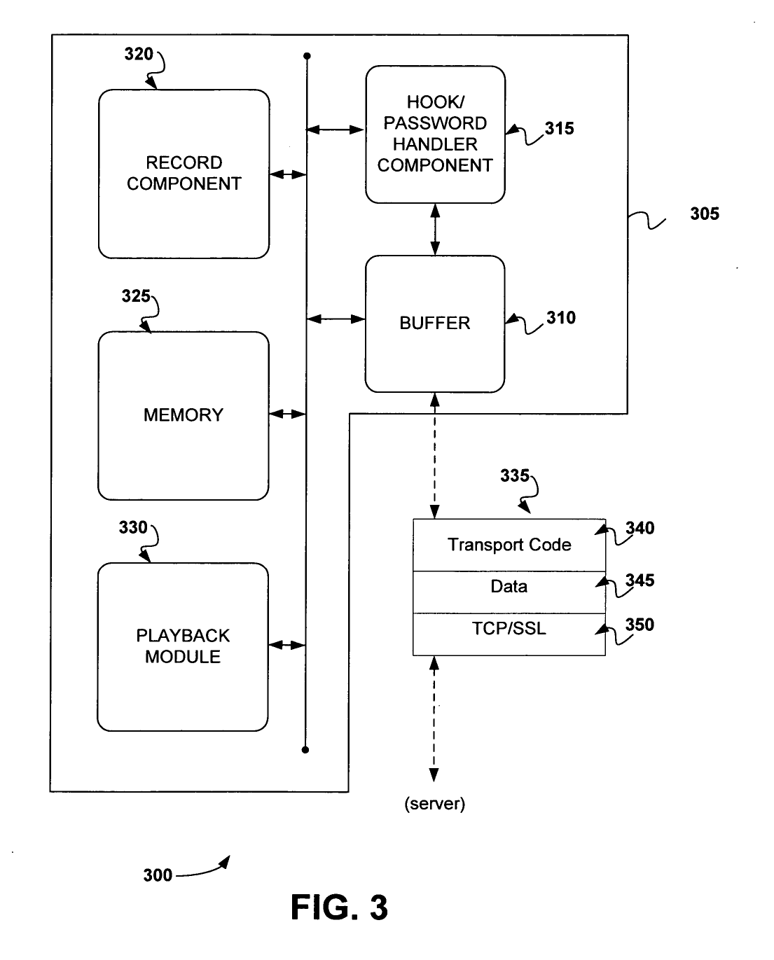

FIG. 3 illustrates a low level block diagram of a recording system 300 in accordance with at least one aspect of the subject invention. The recording system 300 can include a device 305, a buffer 310, a hook/password handler component 315, a record component 320, a memory 325, a playback module 330, and a response 335. The response 335 can include a transport code layer 340, response data 345, and a transport control protocol/secure sockets layer (TCP/SSL) 350. It is understood that the response 335 can have additional layers, and that the TCP/SSL 350 need not be a single layer. However, for purposes of simplicity, FIG. 3 depicts TCP/SSL 350 as a single layer. Thus, the transport control protocol can make up a single layer of the response 335, and the secure sockets layer can make up a separate single layer of the response 335 as well. For the purposes of FIG. 3, response 335 is a server response sent to the device 305 during a server/device conversation being recorded by the device 305. It is appreciated that such a server/device conversation can be made up of a plurality of responses from the device 305 and/or one or more servers.

In the aspect illustrated in FIG. 3, the server response 335 can be sent by a server and received by the device 305 at the buffer 310. The record component 320 manages the hook/password handler component 315 to filter and capture the response data 345 from the server response 335. The hook/password handler component 315 hooks into, or extracts, the response data 345 located above the TCP/SSL 350, but below the transport code layer 340. The hook/password handler component 315 can also replace any password information in the response data 345 with random data in order to provide security during playback. The record component 320 can then store a record of the response data 345 and/or the server response 335 in memory 325 as part of a log file. Such a log file can be, for example, a plaintext file. It is to be appreciated that device responses from the device can be similarly captured, filtered, and stored in memory 325 along with corresponding server responses to create a complete log in memory 325 of the entire server/device conversation. It is also noted that other processes and procedures can be executed on and/or from the device while the device is recording a server/device conversation, and that such recording does not interfere and/or hinder the actual server/device conversation that is being recorded.

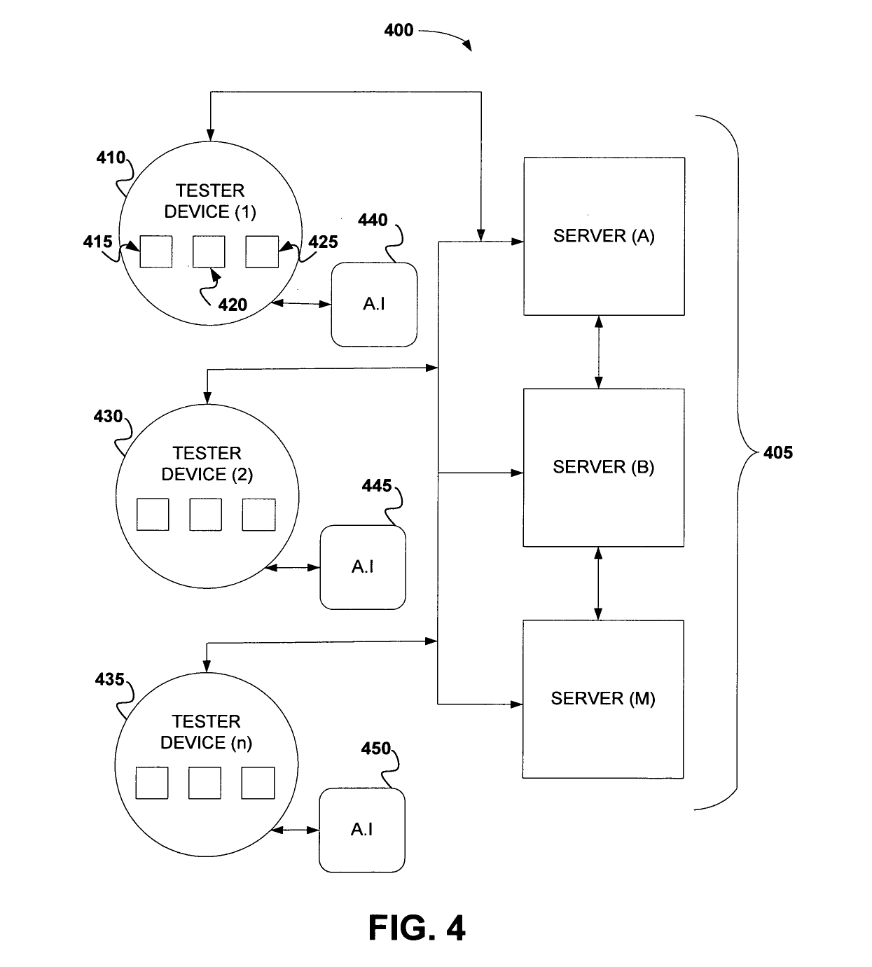

FIG. 4 illustrates a testing matrix 400 utilizing artificial intelligence and one or more aspects of the subject invention. The testing matrix 400 includes a server cluster 405 with a plurality of servers. The matrix further includes a plurality of testing devices 410 that includes a record component 415, a playback module 420, and a response buffer 425. In addition, the testing matrix 400 further provides additional testing devices 430, 435, and each testing device 410, 430, 435 can each have an artificial intelligence component 440, 445, 450 either coupled to and/or integrated with a corresponding device 410, 430, 435. It is understood that device 430 and device 435 can include internal components and modules similar to those of testing device 410, as illustrated. In addition, although otherwise illustrated, the testing matrix 400 is not limited to a particular number of testing devices and/or servers.

Continuing with the example, each device 410, 430, 435 can record a POP3/IMAP4/SMTP server/device communication. The recording of the communication can occur on the device, above the SSL and TCP/IP layers, but below the transport code that actions on the data received from the server (e.g., unpack a message, parse a folder list, etc.). The recorded data can be stored on the device in a log file as a plaintext file located in a ToxicLogs directory, for example. One recording situation, as an example, occurs from a fresh device with its first sync to a server. This can eliminate several staging challenges that can occur later (e.g., reproducing existing folders/messages on the device).

A trigger capable of recording on each of the devices 410, 430, 435 can be a detection of the presence of a ToxicD.dll device file, for example, as a trigger file. If this file is found by the POP3/IMAP4/SMTP transport, it will call a record application program interface within the device it is interacting with in order to begin recording server/device communications. In order to minimize security concerns regarding password disclosure, the record component 415 of each device can been special cased to handle writing a password to the plaintext log. When the component 415 detects a password being written, it can write garbage characters into the plaintext file instead. It is understood that each device 410, 430, 435 can record independently of each other, and that the respective plaintext files of each device 410, 430, 435 can be distinct.

Each device 410, 430, 435 can also playback the plaintext log it previously recorded. This simulates a real server without having a network connection or an actual connection to the server that the fault, for example, originated on. To begin playback on a device, one or more registry keys can be set and the device can be staged exactly the way it was when the plaintext log file was recorded. Staging each device 410, 430, 435 can include, for example, but is not limited to, the following: (1) the POP3IMAP4SMTP service of the server cluster 405 to be created with the same values it had when the plaintext log file was created in order to set the incoming/outgoing server names, usernames, passwords, day filters, etc., (2) folders or messages that were sunk down to the device via previous server sessions to be staged (or recreated), (3) outgoing mails or draft mails can be recreated within the respective folders, (4) the registry DWORD value SOFTWARE\Inbox\ToxicReplayFlag can be set to 1, (5) the registry STRING value ToxicLogDir can be set to the path of the log file, (6) the registry STRING value SOFTWARE\Inbox\SMTPLog can be set to the name of the SMTP log filename, (7) the registry STRING value SOFTWARE\Inbox\IMAPHeaderLog and registry STRING value SOFTWARE\Inbox\IMAPBodyLog can be set to the respective IMAP header and body log filename, (8) the registry STRING value SOFTWARE\ Inbox\POP3Log can be set to the POP3 log filename. Finally, it is understood that the staging of a device can be independent of other devices in the testing matrix 400.

When staging of each device 410, 430, 435 is sufficient, each device 410, 430, 435 can be in the identical state at when each plaintext log was created. Thus, any communications each device 410, 430, 435 sends out can match up within the log files. The playback module 420 of device 410, for example, can match up all outgoing communications with the corresponding response from the server and ‘play’ that response back to device 410. Each device 410, 430, 435,during playback, can think it is receiving a response from a server and can act accordingly. This identical playback can allow the reproduction of the same response from a server that developers can reproduce a problem to identify a fix. Once a developer has implemented a fix for the problem, a tester can take that same plaintext log file and play it back to confirm a device 410, 430, 435 now correctly handles what was once a failing case. At a later point in time, the tester can replay that same log to confirm the fixed functionality had not regressed from the fixed state.

At least one of the novel aspects of the subject invention utilized by testing matrix 405 is that record and playback can be solely device based. The playback can occur on each device 410, 430, 435 before the TCP/IP layer is actually used, for example. For example, in accordance with the invention, a network connection is not required to utilize the playback feature. Removing the requirement for a network connection means that recorded logs from any server on any network can be used.

As noted in the aspects described supra, actual passwords are not included within the log files. Instead, when each device 410, 430, 435 receives the password from the device during playback, it can respond back with a positive response. Meaning that if device 430 sends a different password than when the recording was originally made, the playback module of device 430 can assume the original correct password had been sent.

Further, artificial intelligence components 440, 445, 450 (e.g., explicitly and/or implicitly trained classifiers) can be employed with each device 410, 430, 435, respectively, in connection with performing inference and/or probabilistic determinations and/or statistical-based determinations as in accordance with one or more aspects of the subject invention. The term “inference” refers generally to the process of reasoning about or inferring states of the system, environment, and/or tester from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the testing matrix 400. In addition, artificial intelligence components 440, 445, 450 can be employed to determine whether to have the respective device 410, 430, 435 to record depending on a number of factors, such as, user identity, user behavior, user information, device type, data type, and data traffic, etc.

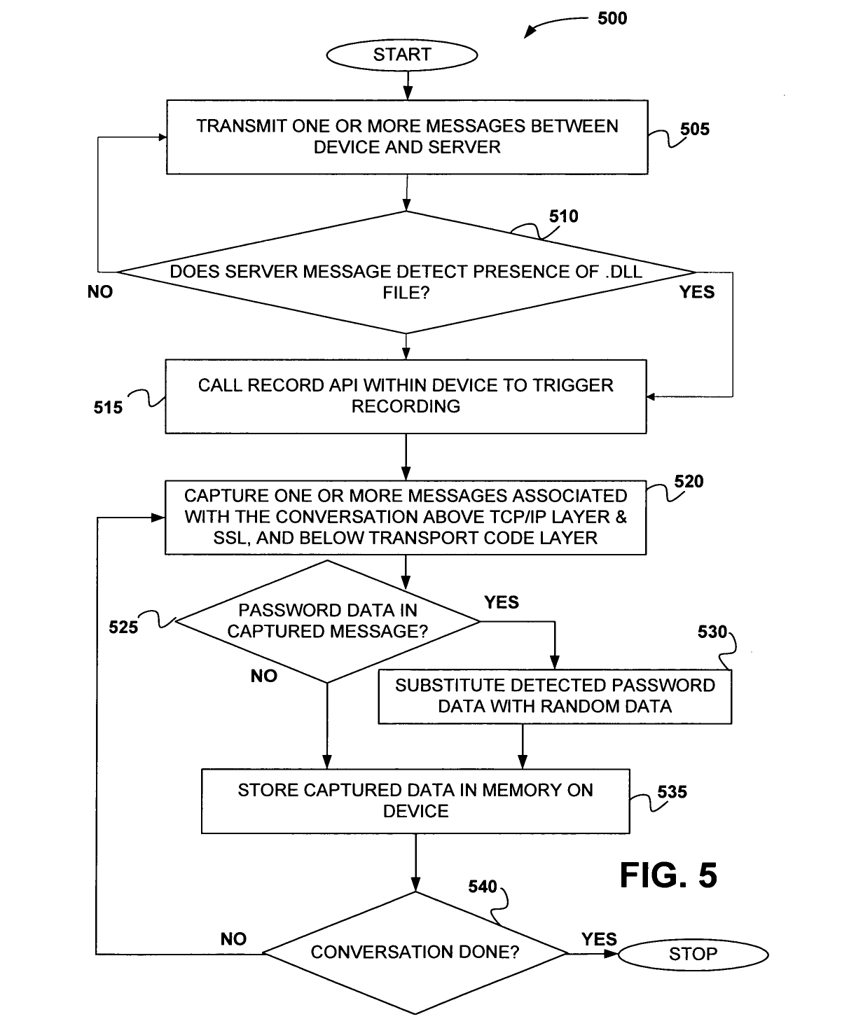

FIGS. 5-8 illustrate methodologies and/or flow charts in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 5 illustrates a flow diagram of a method 500 of recording in accordance with at least one aspect of the subject invention. At act 505, a conversation made up of one or more messages can be transmitted between a device and a server. It is to be appreciated that such transmission can last continuously as the method 500 is executed until the conversation is terminated. At act 510, a determination can be made whether to begin recording transmitted messages based upon a server message detecting a particular file (e.g, .dll file) in the device. In the example, the presence of a particular .dll file can be employed as a trigger. If such a file is not detected, message transmission can continue without the device recording the conversation. However, if the particular file is detected, then the device can call an application program interface to begin recording the conversation at act 515. At act 520, each outgoing message and incoming message of the conversation can be captured in order to process and eventually log message data situated above the TCP/IP and SSL layers, but below the transport code layer of each message. Next, at act 525, a determination can be made if password data is included in the captured message. Password data can be replaced with random data at act 530 and the method 500 moves on to act 535. However, if no password data is found at act 525, then the method 500 can bypass act 530 and store the captured data in memory on the device in order to create a log file of the conversation at act 535. At act 540, a determination is made if the conversation is done. If the conversation is not set to terminate, the method can return to act 520 in order to keep processing, capturing, and storing conversation messages, as discussed supra.

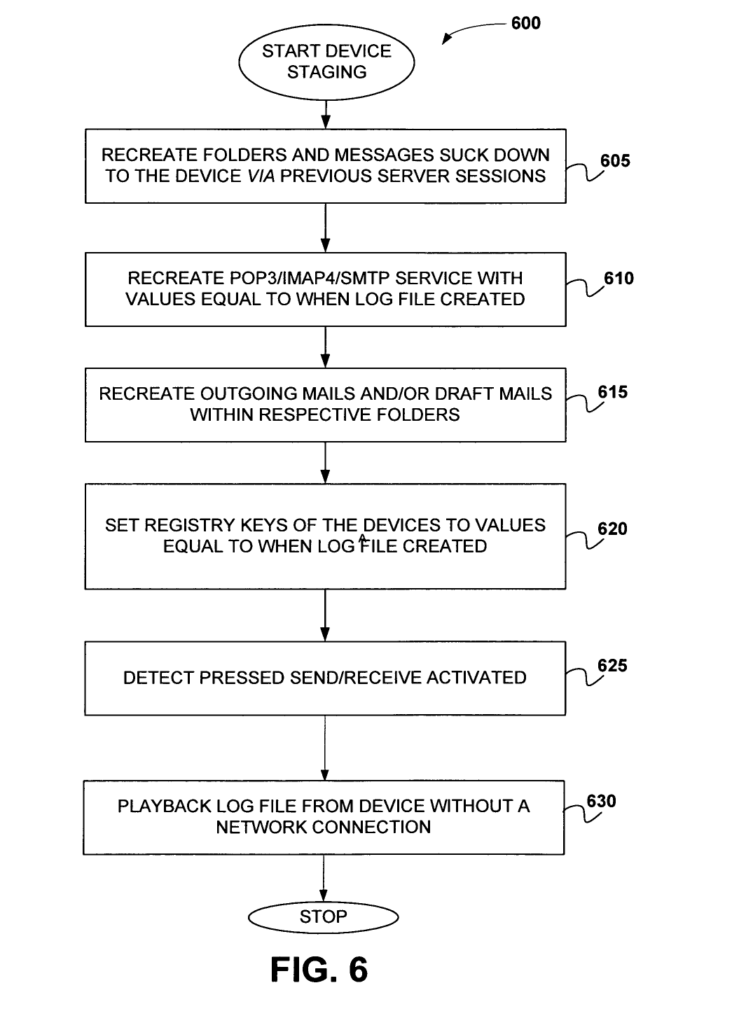

FIG. 6 illustrates a flow diagram of a method 600 of staging in accordance with at least one aspect of the subject invention. Method 600 relates to staging a device in order to prepare a device for playback of a server/device conversation log file. Thus, to begin playback, a plurality of registry keys can be set and the device can be staged exactly the way it was when the conversation log file was recorded. At act 605, folders and/or messages that were sunk down to the device via previous server sessions can be staged (and/or recreated). At act 610, the POP3/IMAP4/SMTP service can be created with the same values it had when the conversation log file was created. Act 610 can set incoming/outgoing server names, usernames, passwords, day filters, etc. At act 615, outgoing mails or draft mails can be recreated within respective folders. At act 620, registry keys of the device can be set to values equal to when the conversation log file was created. As an example: the registry DWORD value SOFTWARE\Inbox\ToxicReplayFlag can be set to 1, the registry STRING value SOFTWARE\Inbox\ToxicLogDir can be set to the path of the log file, the registry STRING value SOFTWARE\Inbox\SMTPLog can be set to the name of the SMTP log filename, the registry STRING value SOFTWARE\Inbox\IMAPHeaderLog and registry STRING value SOFTWARE\Inbox\IMAPBodyLog can be set to the respective IMAP header and body log filename, the registry STRING value SOFTWARE\Inbox\POP3Log can be set to the POP3 log filename. At act 625, method 600 can detect an activated send/receive button of the device. At act 630, with the device properly staged, the device can begin playback of the conversation log file to the device without a network connection.

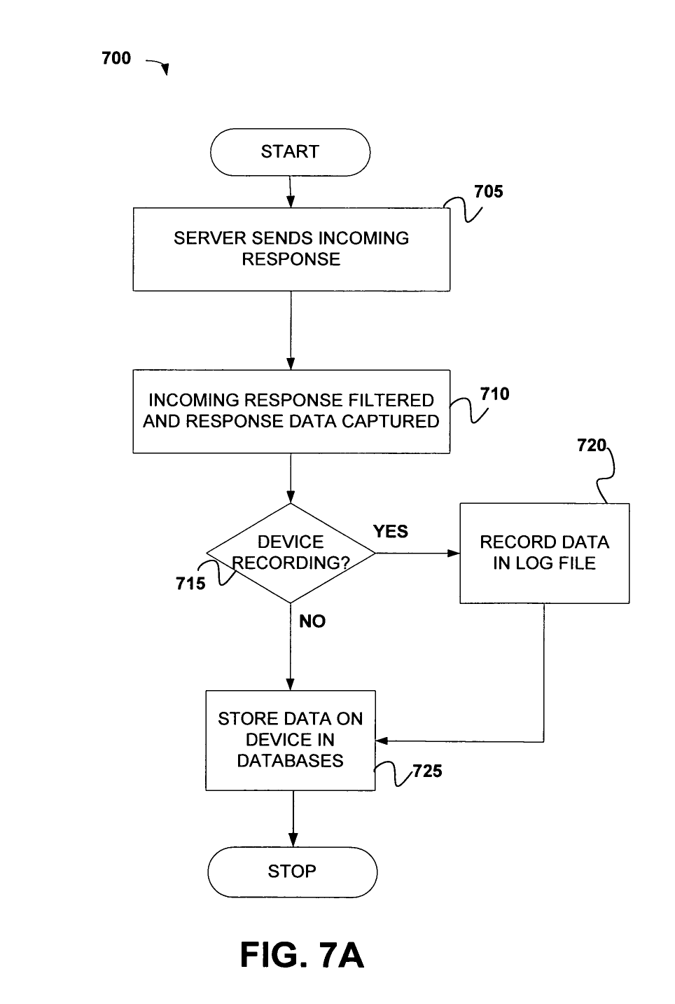

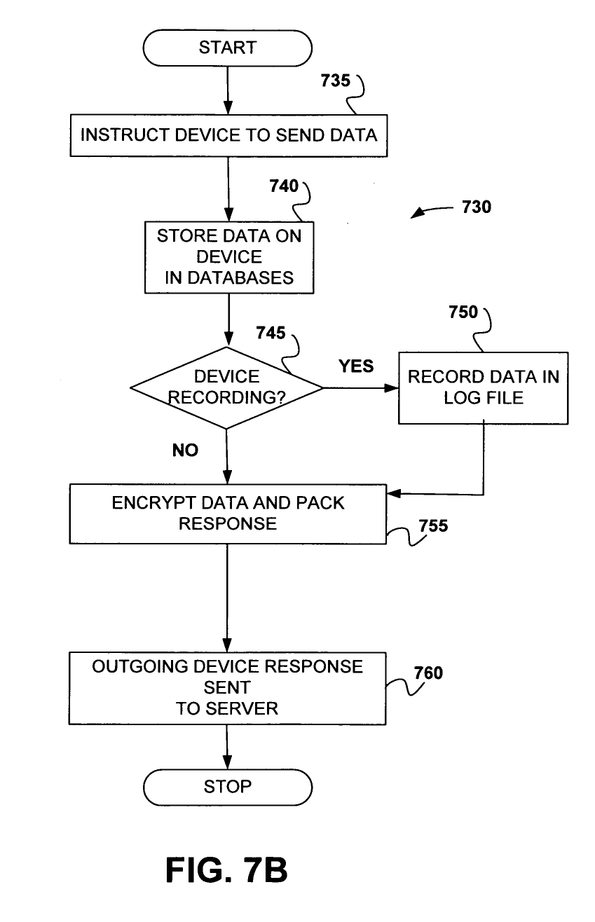

FIG. 7A illustrates a flow diagram of a server response record method 700 in accordance with at least one aspect of the subject invention. At act 705, a server can send a response to the device as part of a server/device conversation. As described supra, the conversation is not limited to one server response. The device can intake the server response, filter the response and capture response data at act 710. For instance, such filtering can include unpacking layers of the response in order to access response data. Capturing the response data can include modifying password information in the response data and organizing the response data in a desired format. At act 715, a determination can be made whether the device is recording the server/device conversation. Upon an affirmative determination, the captured data can be recorded as a log file at act 720. At act 725, the same captured data can be stored on the device in databases for current use during the conversation and/or for processing by other algorithms of the device. If, at act 715, a negative determination is made as to whether or not the device is recording, method 700 forwards the captured data to act 725 and bypasses act 720.

FIG. 7B illustrates a flow diagram of a device response record method 730 in accordance with at least one aspect of the subject invention. At act 735, the device can respond to internal and/or external instructions to send data to the server. At act 740, the data to be sent can be stored on the device in databases for current use during the conversations and/or for processing by other algorithms of the device. At act 745, a determination can be made whether the device is recording the server/device conversation. Upon an affirmative determination, the data to be sent can be recorded in a log file at act 750. At act 755, the data can be encrypted and packed as a response with various layers (e.g., TCP/IP, SSL) to facilitate transmission. At act 760, the outgoing device response can be sent to the server. If, at act 745, a negative determination is made as to whether or not the device is recording, the data to be sent is forwarded to act 755 and bypasses act 750.

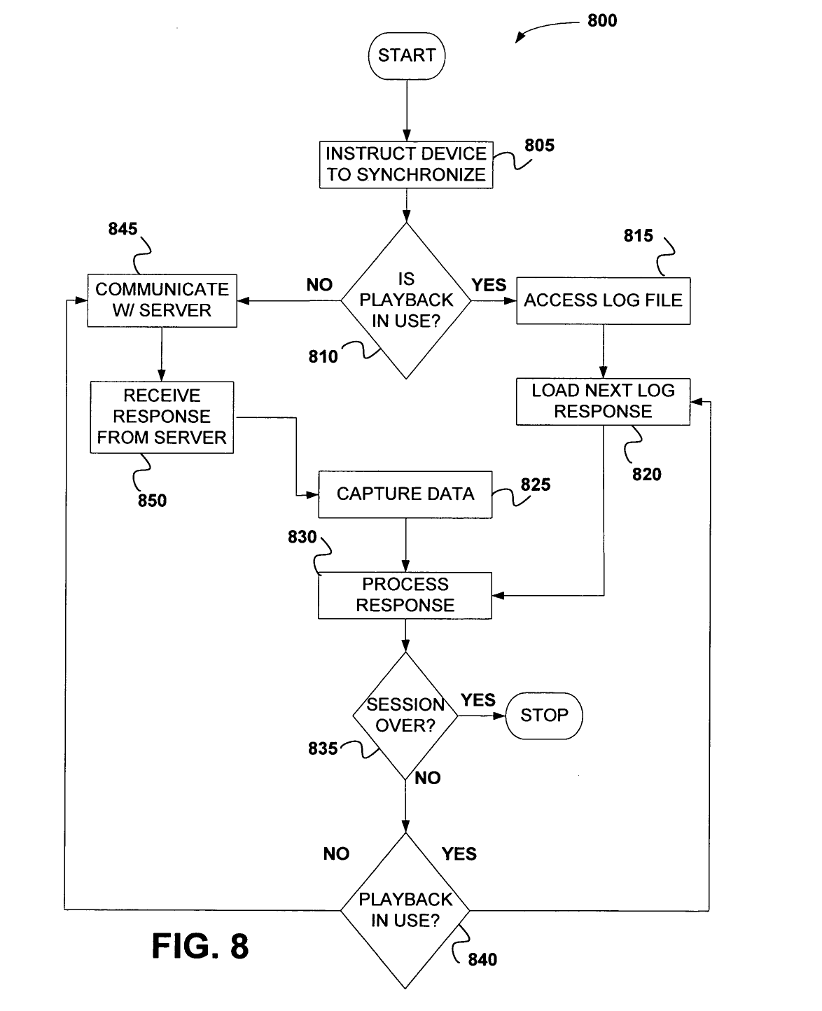

FIG. 8 illustrates a flow diagram of a playback method 800 in accordance with at least one aspect of the subject invention. At act 805, a device is synchronized in order to communicate outgoing and incoming responses with a server. Such communication can include the exchange of a plurality of device and server responses, each comprising response data, between the device and the server. At act 810, a determination is made whether the device is in playback mode. Upon an affirmative determination that playback is occurring, a log file of responses is accessed at act 815. Such a log file can be a plaintext file, for example, as a recording of previous responses between the device and a server. By transmitting the log file, the playback of method 800 can simulate a previous server communication without requiring the device to have a network connection. At act 820, a recorded response can be loaded from the log file in device memory that will be sent back to the device. During playback, act 825 can be bypassed, and the device processes the recorded response in the same way it would receive and process a response during ‘live’ communication with a server at 830. Hence, the device does not discern that is processing a previous server communication. The device at 830 acts on the recorded response as though it was a current communication received from an actual server. At 835, if the device has not received any data from the played back communication indicating that the session is over, it will repeat the appropriate response capturing routine starting from act 840, based on a determination of whether or not the device playing back responses to the device. If the session is complete, playback will be terminated. It is to be understood that acts 805-840 can occur within the physical device itself. Acts 845 and 850, however, can occur between a server and the device and the acts can be triggered upon a negative determination at 810. As to 845, after a determination that a log file is not being played back, communications can be sent between the device and the server. Accordingly, server responses can be received at 850.

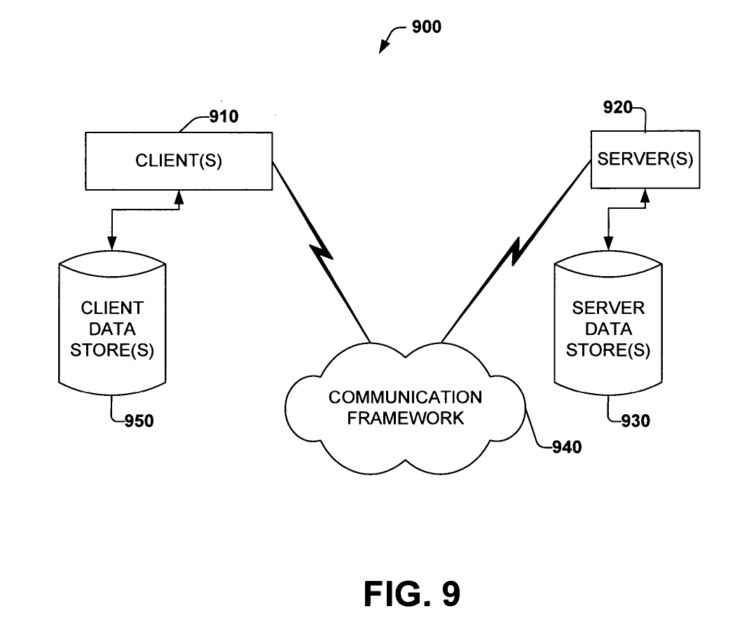

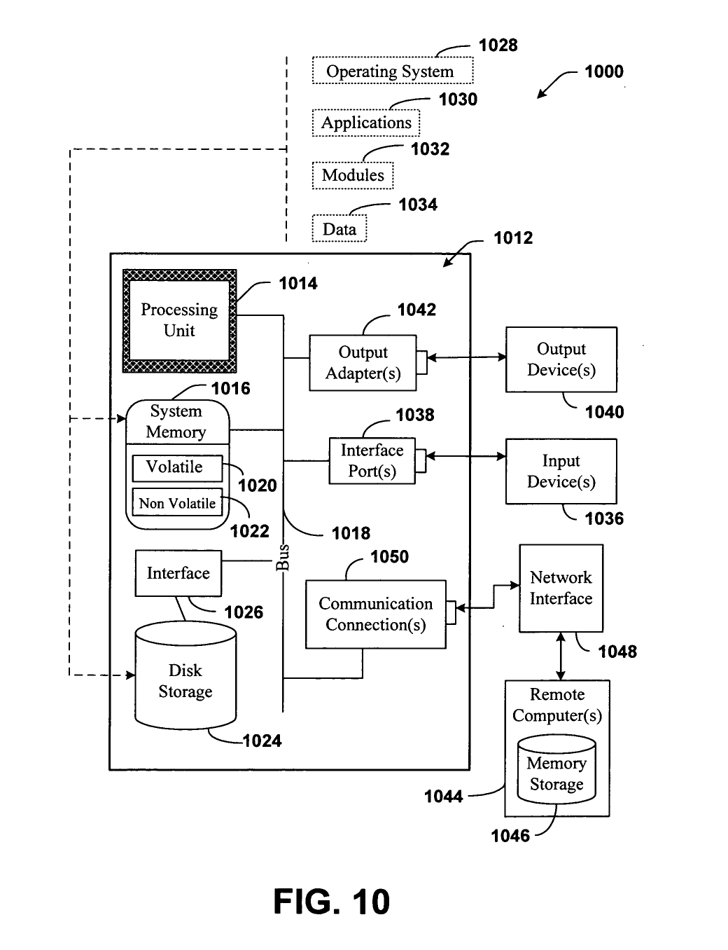

In order to provide additional context for implementing various aspects of the subject invention, FIGS. 9-10 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 9 is a schematic block diagram of a sample-computing environment 900 with which the subject invention can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject invention, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 940.

With reference to FIG. 10, an exemplary environment 1000 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1094), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A record and playback system, comprising:
a module integrated with a device, the module plays back at least one recorded server response to the device without a network connection, the at least one recorded server response that is played back is matched to at least one recorded device response.

2. The system of claim 1, further comprising a component integrated with the device that records at least one server response and at least one device response on the device and stores the at least one recorded server response and the at least one recorded device response in a memory of the device.

3. The system of claim 2, the at least one server response and the at least one device response each comprise at least one of a Secure Sockets Layer (SSL), a Transmission Control Protocol/Internet Protocol (TCP/IP) layer, and a transport code layer.

4. The system of claim 2, the at least one server response comprises server response data below the transport code layer and above the TCP/IP layer and the SSL and the at least one device response comprises device response data below the transport code layer and above the TCP/IP layer and SSL.

5. The system of claim 1, the device comprises a data hook that captures server response data to create the at least recorded server response and captures device response data to create the at least one recorded device response and facilitates the module to forward the at least one recorded server response and the at least one recorded device response to the memory of the device.

6. The system of claim 1, the device comprises a password handler component that detects at least one password character in the at least one device response and substitutes the at least one password character with at least one random character in the recorded device response associated with the device response.

7. The system of claim 6, the password handler component further facilitates the module to play back a positive response to the device when the module detects at least one password character in the at least one device response.

8. The system of claim 1, the device comprises a staging module that sets the device to a state equal to when the at least one recorded server response was generated.

9. The system of claim 8, the state comprising at least one recreated folder and at least one recreated message sunk down to the device via one or more previous server sessions, one or more recreated values associated with a POP3/IMAP4/SMTP service, and at least one recreated outgoing mail and draft mail, and at least one registry key set to a value equal to when the at least one recorded server response was generated, and at least one activated Send/Receive button of the device.

10. The system of claim 1, the device further comprising a trigger file that calls a record application program interface of the device when the trigger file is detected by an initial server response.

11. A server communication playback method, comprising:
initiating a conversation between a device and at least one server;
recording the conversation on the device;
storing a record of the conversation in a memory of the device as a plaintext file; and
transmitting the record back to the device without a network connection and at a device state equal to when the plaintext file was created.

12. The method of claim 11, the act of initiating a conversation comprises exchanging one or more device messages and one or more server messages.

13. The method of claim 12, the one or more device messages and the one or more server messages each comprising at least one secure layer, at least one transmission protocol layer, at least one transport code layer, the one or more server messages further comprising a file detector.

14. The method of claim 11, the act of recording the conversation comprises:
capturing data of the one or more device messages and the one or more server messages, the data being situated above the secure layer and the transmission protocol layer and below the transport code layer of each of the one or more device messages and the one or more server messages;
determining whether the captured data comprises password data;
replacing the password data with garbage data in the captured data when the captured data comprises password data; and
entering the captured data into the plaintext file.

15. The method of claim 11, the act of recording the conversation further comprises:
receiving an initial server message to the device that employs the file detector to detect the presence of a flagged device file; and
triggering the act of recording of the conversation based on the presence of the flagged device file.

16. The method of claim 15, the act of triggering the recording of the conversation comprises calling a record program interface to initialize recording.

17. The method of claim 11, transmitting the record back to the device comprises performing a staging sequence to recreate a device state equal to when the plaintext file was created.

18. The method of claim 17, performing a staging sequence comprises:
setting at least one registry key of the device to a value equal to when the plaintext file was created;
recreating at least one folder and at least one message sunk down to the device via previous server sessions.

19. The method of claim 17, performing a staging sequence further comprises:
recreating at least one server service equal to when the plaintext file was created; and
detecting an activated Send/Receive button of the device.

20. A server communication playback system, comprising:
means for initiating a conversation between a device and at least one server;
means for recording the conversation on the device;
means for storing a record of the conversation in a memory of the device as a plaintext file; and
means for transmitting the record back from the device without a network connection and at a device state equal to when the record was created.
